(19) United States
(12) Patent Application Publication
(10) Pub. No.: US 2016/0298057 A1
(43) Pub. Date: Oct. 13, 2016

(54) Machine Cleaning Composition

(71) Applicant: RECKITT BENCKISER (BRANDS) LIMITED, Berkshire (GB)

(72) Inventors: Judith Preuschen, Heidelberg (DE); Lucia Krubasik, Copenhagen (DK)

(73) Assignee: Reckitt Benckiser (Brands) Limited, Slough (GB)

(21) Appl. No.: 15/036,178

(22) PCT Filed: Oct. 31, 2014
(86) PCT No.: PCT/GB2014/053245

§ 371 Date: May 12, 2016

(30) Foreign Application Priority Data
Nov. 15, 2013 (GB) 1320176.9

(51) Int. Cl. C11D 1/66; A47L 15/00; C11D 17/04; C11D 11/00; C11D 17/00; C11D 3/33

(52) U.S. Cl. CPC C11D 1/662; C11D 17/0013; C11D 3/33; C11D 17/003; C11D 17/043; C11D 11/0041; A47L 15/0002; A47L 2601/00

(57) ABSTRACT

The invention relates to a dishwasher machine cleaning detergent composition that is capable of being used during a normal dishwashing cleaning cycle.

### TECHNICAL FIELD

This invention relates to a composition having machine-cleaning properties for use during the wash cycles of automatic dishwashing machines, and a method of using said composition.

### BACKGROUND TO THE INVENTION

It is well known that dirt and grime can build up in dishwashers over time through regular use. In particular heavy animal fats are problematic. The fatty deposits also can lead to malodour as they degrade.

In addition to the formation of bad odours, fatty soil particles may clog the filter. This may cause problems with the circulation of the wash and rinse waters leading to poor cleaning results including increased re-deposition of soils on the articles being washed in the dishwashing machine and on the interior surfaces of the machine.

This problem is becoming more important as energy and environmental concerns are leading to the use of lower wash temperatures. Lower wash temperatures mean that certain fats are difficult to emulsify leading to increased deposits inside the machine.

These problems can be over-come by the use of a dedicated machine cleaning detergent composition. Most conventional dishwasher machine cleaners are based on organic acids and surfactants to treat lime scale deposits and grease/fat build-up.

Machine cleaning tablets, e.g. for use in automatic dishwashers, are known from e.g. US 2003/0032568 which discloses compositions comprising lime-scale remover acid, non-ionic surfactants and certain types of detergency enzyme.

Machine cleaning liquid compositions comprising a combination of acids and surfactants are also known from WO 2007/060439 A1.

However the use of these compositions by dishwasher containing households is lower than desired. This is largely presumed to be because one of the big drawbacks to the prior art compositions above is that they require the use of a cleaning cycle (usually as hot as possible) in an empty machine. In other words the consumer has to run a full cleaning cycle usually at high temperatures, without being able to clean soiled kitchen or table ware at the same time. This is perceived to be wasteful by most consumers.

The reason that the machine cleaning compositions of the prior art cannot be used in combination with normal detergents in a tableware cleaning cycle is that these compositions counteract each other. Dishwasher machine cleaning compositions are generally strongly acidic, while most dishwashing detergent compositions are alkaline.

It is an object of the present invention to provide a machine cleaning composition that can overcome this problem.

### STATEMENTS OF INVENTION

According to a first aspect of the present invention there is provided a machine cleaning dishwasher detergent composition, wherein the detergent composition has a pH greater than or equal to 7, wherein the composition includes an alkyl polyglycoside surfactant and a builder wherein the machine cleaning detergent composition is suitable for use concurrently with a main detergent composition in a normal cleaning wash or rinse cycle to clean soiled tableware.

Preferably the alkyl polyglycoside is an alkyl polyglucoside.

Preferably the builder is an amino acid based builder. Preferably the amino acid based builder is selected from MGDA (methylglycine diacetic acid) or GLDA (glutamic acid diacetic acid) or a combination of the two thereof.

Thus, in accordance with the present invention the compositions of the first aspect of the invention are used in one or more wash and/or rinse cycles of an automatic dishwashing machine to remove fatty soils from the interior of the machine e.g. from the pipes, filter metal surfaces and plastic items.

According to the second aspect of the present invention, there is provided a method of treating the interior of an automatic dishwashing machine to prevent or remove the build-up of fatty soils, the method comprising applying the composition of the first aspect to the interior of the machine during one or more wash or rinse cycle(s) of the dishwasher.

This cleaning operation is ideally carried out without the need for additional wash and/or rinse cycles of the automatic dishwasher such as would be necessary if the machine cleaning operation was carried out by running a wash and/or rinse cycle in an empty machine.

Accordingly, and preferably the compositions of the present invention are typically used in a wash and/or rinse cycles of the automatic dishwasher containing items, e.g. kitchenware, to be cleaned or rinsed.

### DETAILED DESCRIPTION OF THE INVENTION

The present invention will now be described in further detail.

Weight percentages: For the purposes of this specification a reference to the percentage amount of the defined component is to its percentage by weight on the total weight of the composition, unless otherwise stated.

Regular dishwasher detergent: For the purposes of this invention this is taken to mean any detergent formulated for the cleaning of kitchen and table ware in an automatic dishwasher.

Unit dose: Premeasured quantity of detergent composition suitable for a single wash cycle.

The compositions of the invention are intended to remove fatty soils, especially animal and plant derived fat soils, which may otherwise be difficult to remove from the interior of the dishwashing machine, e.g. from the pipes, filter and plastic items. This allows the compositions of the invention to be used to either remove or reduce existing build-up of fatty soils in the interior of the machine and to help prevent build-up when used regularly in the wash and/or rinse cycle. These two modes of action may provide a machine maintenance effect.

The compositions of the invention may be applied to the interior cavity of the dishwasher by introducing the compositions into the dispensing means (built-in or self-standing) of the dishwashing machine and subsequently being released into the interior cavity of the machine during a wash or rinse cycle.

Alternatively the compositions may be added directly into the interior cavity of the dishwashing machine. This may be the alternative favoured should the machine be run with soiled kitchen or tableware to be cleaned. In this situation the dispensing means may already be occupied to dispense the regular dishwasher detergent used to clean soiled tableware

In both cases it is the action of the wash/rinse water which distributes the composition through the interior cavity and thus applies it to the soils to be removed. Accordingly, the compositions may be applied to the soils in a form which has been diluted with the wash/rinse water.

The inventors have surprisingly found an effective machine cleaning formulation that can operate alongside a normal tableware cleaning detergent in an automatic dishwasher. The machine cleaning detergent composition may operate at the same pH as regular dishwasher detergent and therefore does not interfere with the action of the regular detergent. The machine cleaning detergent compositions of the present invention are extremely efficacious in removing fatty soils at even low wash cycle temperatures.

The machine cleaning detergent compositions of the present invention comprise an alkyl polyglycoside surfactant and a builder and are formulated to have a pH of at least 7.

Alkyl polyglycosides are a class of non-ionic surfactants. They are derived from sugars and fatty alcohols; therefore, they are generally favoured for their manufacture from renewable resources. The raw materials for industrial manufacture are typically starch and fat, and the final products are typically complex mixtures of compounds with different sugars comprising the hydrophilic end and alkyl groups of variable length comprising the hydrophobic end.

When derived from glucose, these surfactants are known as alkyl polyglucosides. Alkyl glycosides are produced by direct synthesis from higher mono-functional alcohols and powdered glycoses, in particular anhydrous glucose and/or glucose monohydrate, in the presence of acid catalysts at elevated temperatures.

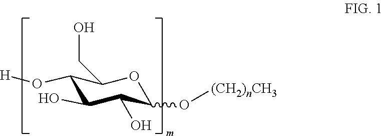

FIG. 1 shows the general formula for alkyl polyglucosides. Preferably the alkyl polyglycoside used in the compositions of the present invention is an alkyl polyglycoside.

For the purposes of the present invention the alkyl chain of the alkyl glycoside may be between two and twenty four carbons in length, preferably the alkyl chain may be between six and twenty carbons in length, more preferably the alkyl chain may be between eight and sixteen carbons in length and most preferably the alkyl chain may be between ten and fourteen carbons in length.

For the purposes of the present invention the sugar component of the alkyl glycoside may be between 1 and 10 moles per alkyl chain, preferably between 1.4 moles and 6 moles per alkyl chain and most preferably between 1.6 moles and 3 moles per alkyl chain

Alkyl glycosides are prepared in mixtures. The above figures in terms of chain length and sugar content are only averages.

Preferably the machine cleaning detergent compositions of the present invention comprise between 0.1 and 50% by weight of a polyglycoside surfactant, more preferably between 0.5 and 25% by weight, more preferably between 1 and 10% by weight and most preferably between 2 and 5% by weight of an alkyl polyglycoside.

An example of a suitable alkyl glucoside for use in the present invention is Lauryl Glucoside.

Another example of a suitable alkyl glucoside for use in the present invention is made by BASF and marketed under the trade name of Glucopon 600CSUP.

Preferably the builder used is a non-phosphate builder. However phosphates may also be used if required. Preferably the builder is selected from the group consisting of MGDA, GLDA, citrate, IDS, PAS, modified PAS, malonyl lactate, mono lactate, polyacrylates.

Most preferably the builder is an amino acid based builder. The present inventers have found the combination of an alkyl glucoside and GLDA and/or MGDA to be especially favoured in terms of performance and storage stability of the compositions.

Most preferably the builder is GLDA.

The builder comprises between 2 and 90% of the machine cleaning detergent composition, preferably between 10 and 80%, more preferably between 30 and 75% and most preferably between 50 and 70% of the machine cleaning detergent composition.

The detergent compositions of the present invention may be of any suitable form, including paste, liquid, solid (such as tablets, powder/granules), foam or gel or any mixture of the above in a multiphase composition.

The composition may be in the form of a unit dose product, i.e. a form which is designed to be used as a single portion of detergent composition in a washing operation. Of course, one or more of such single portions may be used in a cleaning operation.

Solid forms include, for example, in the form of a tablet, rod, ball or lozenge. The composition may be a particulate form, loose or pressed to shape or may be formed by injection moulding or by casting or by extrusion. The composition may be encased in a water soluble wrapping, for, example of PVOH or a cellulosic material. The solid product may be provided as a portioned product as desired.

The composition may also be in paste, gel or liquid form, including unit dose (portioned products) products. Examples include a paste, gel or liquid product at least partially surrounded by, and preferably substantially enclosed in a water-soluble coating, such as a polyvinyl alcohol package.

This package may for instance take the form of a capsule, a pouch or a moulded casing (such as an injection moulded casing) etc. Preferably the composition is substantially surrounded by such a package, most preferably totally surrounded by such a package. Any such package may contain one or more product formats as referred to herein and the package may contain one or more compartments as desired, for example two, three or four compartments.

If the composition is a liquid or a gel it is preferably an aqueous composition although any suitable solvent may be used. Preferably the composition comprises at least 2% water, preferably at least 5% water and most preferably at least 10% water.

If the compositions are in the form of a viscous liquid or gel they preferably have a viscosity of at least 50 mPas when measured with a Brookfield RV Viscometer at 25 C with Spindle 1 at 30 rpm. The compositions of the invention may be made by any suitable method depending upon their format. Suitable manufacturing methods for detergent compositions are well known in the art and do not require further explanation here.

The compositions of the invention may be typically be formulated as an additive product to be used in addition to the normal dishwashing detergent product. But it may also be co-formulated as a single dishwashing detergent and machine cleaning product per se with the different compositions separated in different layers or compartments of a package.

The inventors have found that the composition of the invention will work in any of the forms above, the compositions of the invention may work best in a liquid or gel format.

Preferably the compositions of the invention are provided in a unit dose form such a in a water-soluble pouch comprising an outer film of PVOH. Preferably the monodose gel or liquid product comprises between 5 and 50 grams of the machine cleaning composition, more preferably between 12 and 35 grams and most preferably between 15 and 25 grams. Ideally the composition comprises 20 grams plus or minus 2 grams.

For long term stability, compositions of the present invention may include a preservative. Non-limiting examples include potassium sorbate.

The compositions may comprise further components as required. These will be well known to the skilled detergent engineer. These may be selected from dyes, anti-foaming agents, co-builders, additional surfactants, anti-deposition agents, polymers, sulphonated polymers, solvents, bleaches etc.

According to the second aspect of the present invention, there is provided a method of treating the interior of an automatic dishwashing machine to prevent or remove the build-up of soils, the method comprising applying the composition of the first aspect to the interior of the machine during one or more wash or rinse cycle(s) of the dishwasher.

It is preferred according to the present invention that the dishwasher is at least partially loaded with articles to be cleaned, e.g. kitchenware or tableware, when the method is carried out. It is also preferred that the compositions of the first aspect of the invention are used in combination with a regular dishwasher detergent.

However it is within the method of the present invention to use the compositions of the first aspect of the invention in a wash or rinse cycle without soiled table or kitchen ware. It is also within the method of the present invention to use the compositions of the present invention in a wash or rinse cycle without the addition of a regular dishwasher detergent to the machine.

Preferably the regular dishwasher detergent is phosphate free and comprises an oxygen based bleach and a non-ionic surfactant.

Examples of highly suitable regular dishwasher detergents are the Finish™ brand of dishwasher detergent products manufactured by Reckitt Benckiser.

The method of the second aspect of the present invention preferably uses a dishwasher wash or rinse cycle with a temperature that is less than or equal to 65° C., more preferably less than or equal to 50° C. and most preferably less than or equal to 40° C.

The compositions of the first aspect of the present invention may be used on a regular basis, such as weekly or once or twice a month etc. Alternatively the compositions may be used in the majority of operations of the dishwashing machine.

Preferably there is provided the use, during one or more wash and/or rinse cycles in an automatic dishwashing machine, of a composition comprising the first aspect of the present invention.

### EXPERIMENTAL

Composition A (Composition of the Invention)

| Component | % |
|---|---|
| Water | 11.4 |
| Thickener | 0.3 |
| Propylene Glycol | 16.5 |
| Dye | 0.3 |
| GLDA* | 66.5 |
| Sulphonated polymer | 2.5 |
| Alkyl polyglucoside | 2.0 |
| Preservative | 0.3 |
| Anti-foam | 0.2 |

*GLDA as a 47% aqueous solution

20g composition sealed in a single compartment PVOH pouch.

To determine the effectiveness of the compositions of the present invention the following experiment was carried out.

2 grams of dyed fat was added in an open beaker in the bottom drawer of a test machine (Bosch auto 3in1 Silence comfort SGS57M22EU). A wash cycle was carried out (40° C. eco wash, using normal tap water) and the filter of the machine was then examined visually to determine fat residues left in the machine.

The fat for the tests was prepared by mixing 2g Bellasan fat +0.5% Fettblau dye for 5mn at 50° C. and cooled down for 1 h before the test.

Results

| | Filter status after |
|---|---|
| | completion |
| Detergents used | of wash cycle |
| Finish All-in-one tablet | Blue fat stains remain |
| Fairy Tablet | Blue fat stains remain |
| Finish all-in-one tablet and composition A | Filter free of blue |
| Tablet in dispenser drawer and composition A | fat stains |
| placed on the base of the machine. | |
| 2 × Finish All-in one tablet | Blue fat stains remain |
| One in dispenser drawer, one placed on base of | |
| the machine | |
| Finish All-in-one tablet and 400 mgs Plurafac ® | Blue fat stains remain |
| LF 223 surfactant | |
| Finish All-in-one tablet and 400 mgs Plurafac ® | Blue fat stains remain |
| LF 132 | |

The regular dishwashing detergent fails to remove the heavy fats from the machine in a normal cleaning operation. The filter of the machine was covered in a film of blue dyed fat.

A combination of the Finish tablet and a PVOH pouch of 20 grams of composition A (according to the invention) however leaves the machine filter free of all fat.

To demonstrate the removal of the fat is not the result of just an increase in the total amount of surfactant provided to the wash cycle, three further experiments were performed.

Firstly a cycle using two detergent tablets was tried. This did not result in an improvement.

Secondly a detergent tablet was used in combination with 400mgs of two other common commercial surfactants Plurafac® LF 223 and Plurafac® LF 132 (manufactured by BASF).

These experiments also left blue fat stains on the filter of the machine, demonstrating that the effect is not dependent only on overall surfactant level.

1. A machine cleaning dishwasher detergent composition comprising:
an alkyl polyglycoside surfactant; and
a builder;
wherein the detergent composition has a pH greater than 7; and
wherein the machine cleaning detergent composition is suitable for use concurrently with a main detergent composition in a normal cleaning cycle to clean soiled tableware.

2. The machine cleaning dishwasher detergent composition of claim 1, wherein the builder is an amino acid based builder.

3. The machine cleaning dishwasher detergent composition of claim 1, wherein the composition has a pH greater than 8.

4. The machine cleaning dishwasher detergent composition of claim 1, wherein the content of alkyl polyglycoside comprises at least 0.5% by weight of the composition.

5. The machine cleaning dishwasher detergent composition of claim 1, wherein the composition is in a gel or liquid form;
wherein the builder selected from the group consisting of MGDA, GLDA, and a combination thereof;
wherein the content of alkyl polyglycoside comprises at least 1% by weight of the composition; and
wherein the detergent composition has a pH greater than 9.

6. The machine cleaning dishwasher detergent composition of claim 5, wherein the gel or liquid is aqueous based and;
wherein the water content is greater than 10% by weight.

7. The machine cleaning dishwasher detergent composition of claim 5, wherein the composition is in unit dose form.

8. The machine cleaning dishwasher detergent composition of claim 7, wherein the unit dose form is contained in a water soluble film comprising polyvinyl alcohol (PVOH).

9. The machine cleaning dishwasher detergent composition of claim 5, wherein the alkyl glycoside has an alkyl chain length between C₄-C₂₀.

10. The machine cleaning dishwasher detergent composition of claim 5, wherein the alkyl glycoside has between 1 mole and 4 moles of glycoside per alkyl chain.

11. A method of treating the interior of a dishwasher comprising:
adding the detergent composition according to claim 1 to the interior of the dishwasher during one or more wash or rinse cycles of the dishwasher.

12. The method of treating the interior of a dishwasher according to claim 11 further comprising placing soiled tableware or kitchenware into the dishwasher prior to one or more wash or rinse cycles.

13. The method of treating the interior of a dishwasher according to claim 12, wherein the temperature of one or more wash cycle or rinse cycles is less than or equal to 65° C.

14. The method of treating the interior of a dishwasher according to claim 11 further comprising concurrently adding a dishwasher tableware and kitchenware cleaning composition to the dishwasher with the composition according to claim 1.

15. The method of treating the interior of a dishwasher according to claim 14, wherein the dishwasher tableware and kitchenware cleaning composition comprises a non-phosphate builder, oxygen based bleach, and a non-ionic surfactant.

16. The method of treating the interior of a dishwasher according to claim 14, wherein the composition of claim 1 is in unit dose form.

17. A method of cleaning a dishwasher that has fatty deposits in its interior as well as cleaning tableware or kitchenware inside the dishwasher, comprising adding at least two different detergent compositions to the interior of the dishwasher during one or more wash or rinse cycles of the dishwasher; wherein the method comprises:
removing fatty deposits from the interior of the dishwasher using the detergent composition according to claim 1; and
cleaning the tableware or kitchenware using a detergent composition which is different from the detergent composition according to claim 1.

18. The machine cleaning dishwasher detergent composition of claim 2, wherein the amino acid based builder is selected from the group consisting of MGDA, GLDA, and a combination thereof.

19. The machine cleaning dishwasher detergent composition of claim 1, wherein the composition has a pH greater than 10.

20. The machine cleaning dishwasher detergent composition of claim 1, wherein the content of alkyl polyglycoside comprises at least 2% by weight of the composition.

21. The machine cleaning dishwasher detergent composition of claim 1, wherein the alkyl glycoside has an alkyl chain length between C₁₀-C₁₄.

22. The machine cleaning dishwasher detergent composition of claim 1, wherein the alkyl glycoside has between 1.6 mole and 2 moles of glycoside per alkyl chain.

23. The method of treating the interior of a dishwasher according to claim 12, wherein the temperature of one or more wash cycle or rinse cycles is less than or equal to 40° C.
